(19) United States
(12) Patent Application Publication
(10) Pub. No.: US 2016/0068271 A1
(43) Pub. Date: Mar. 10, 2016

(54) APPARATUS AND METHODS FOR MIXING STREAMS OF AIR

(71) Applicant: HONEYWELL INTERNATIONAL INC., MORRISTOWN, NJ (US)

(72) Inventors: William Facinelli, Phoenix, AZ (US); Yogendra Yogi Sheoran, Scottsdale, AZ (US); Kader Fellague, Torrance, CA (US)

(73) Assignee: HONEYWELL INTERNATIONAL INC., MORRISTOWN, NJ (US)

(21) Appl. No.: 14/481,054

(22) Filed: Sep. 9, 2014

(51) Int. Cl. B64D 13/08

(52) U.S. Cl. CPC B64D 13/08

(57) ABSTRACT

An environmental control system (ECS) for an aircraft may include a mixing diffuser configured to admit a stream of cold air and a stream of hot air and a reheater-condenser fluidly coupled with an output end of the mixing diffuser. The mixing diffuser may include a diffuser cone with a plurality of holes configured to allow passage of hot air into the stream of cold air so that the cold air and the hot air are combined to produce a mixed airstream. The reheater-condenser may include mixing tabs configured to produce further mixing of the mixed airstream.

### BACKGROUND OF THE INVENTION

The present invention relates to gas mixing and, more particularly, to mixing a hot stream of air with a cold stream of air to attain a single thermally mixed airstream with a uniform temperature.

In a typical aircraft employing an environmental control system (ECS), a cold air stream may be mixed with a hot air stream to produce a temperate air stream that may be introduced into a cabin of the aircraft. Many aircraft employ two or more air conditioning packs which may collectively provide conditioned air to the cabin. Accurate measurement of temperature of individual outputs of the packs may be required so that the packs may be operated in an efficient and well-coordinated manner.

At an output of each pack, cold air may be mixed with hot air to achieve a desired output air temperature. In many instances, thermal stratification of the cold and hot air may occur during mixing. Determination of average temperature of output air may be difficult when the output air is thermally stratified. A failure to accurately determine output air temperature may result in a failure to achieve well coordinated operation of the multiple packs.

As can be seen, there is a need for a system of mixing cold air and hot air in an ECS to produce a mixed air output with a uniform average temperature that may be accurately measured. More particularly there is a need for such a system that may produce output air that is free of thermal stratification.

### SUMMARY OF THE INVENTION

In one aspect of the present invention, an environmental control system (ECS) for an aircraft may comprise: a mixing diffuser configured to admit a stream of cold air and a stream of hot air; and a reheater-condenser fluidly coupled with an output end of the mixing diffuser, wherein the mixing diffuser includes a diffuser cone with a plurality of holes configured to allow passage of hot air into the stream of cold air so that the cold air and the hot air are combined to produce a mixed airstream, and wherein the reheater-condenser includes mixing tabs configured produce further mixing of the mixed air stream.

In another aspect of the present invention, an environmental control system (ECS) for an aircraft may comprise a mixing diffuser configured to admit a stream of cold air and a stream of hot air, the mixing diffuser including a diffuser cone with a plurality of holes configured to allow passage of hot air into the stream of cold air so that the cold air and the hot air are combined to produce a mixed airstream.

In still another aspect of the present invention, an environmental control system (ECS) for an aircraft may comprise a reheater-condenser fluidly coupled with an output end of a mixing diffuser to receive a mixed air stream from said output end, the reheater-condenser including mixing tabs configured to produce further mixing of a mixed air stream emerging from the mixing diffuser.

These and other features, aspects and advantages of the present invention will become better understood with reference to the following drawings, description and claims.

### BRIEF DESCRIPTION OF THE DRAWINGS

FIG. 1 is a perspective view of a portion of an environmental control system in accordance with an exemplary embodiment of the invention;

FIG. 2 is a cut-away elevation view of a mixing diffuser in accordance with an exemplary embodiment of the invention;

FIG. 3 is a cut-away perspective view of a reheater-condenser in accordance with an exemplary embodiment of the invention;

FIG. 4 is a schematic side view of the reheater-condenser of FIG. 3 in accordance with an exemplary embodiment of the invention; and

FIG. 5 is a schematic end view of the reheater-condenser of FIG. 3 in accordance with an exemplary embodiment of the invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

The present invention generally provides an air mixing system that employs mixing chambers with internal devices that promote mixing of streams of air that are introduced into the mixing chambers. More particularly, the present invention provides for an aircraft environmental control system (ECS) in which hot and cold airstreams may be mixed to produce an output air stream free of thermal stratification.

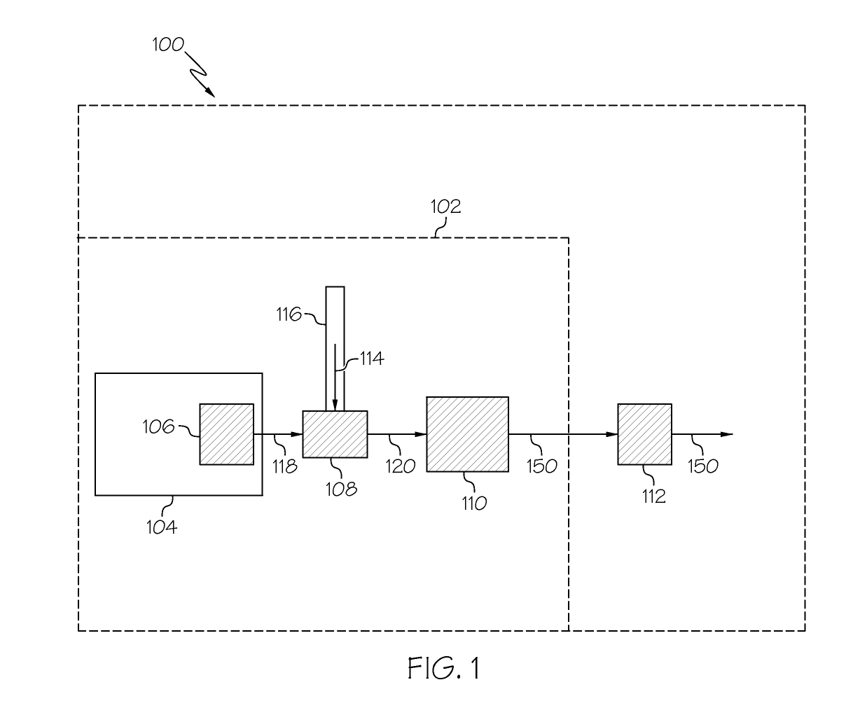

Turning now to the description, FIG. 1 illustrates a portion of an environmental control system (ECS) 100 of an aircraft (not shown). More particularly, FIG. 1 shows a portion of a pack 102 of the ECS 100. The pack 102 may include an air cycle machine 104, an expansion turbine 106, a mixing diffuser 108, a reheater-condenser 110 and a pack discharge sensor (PDS) 112. In operation, a flow of hot air 114 may enter the mixing diffuser 108 from a compressor discharge duct 116. A flow of cold air 118 may enter the mixing diffuser 108 from the expansion turbine 106. A flow of thermally mixed airstream 120 may emerge from the mixing diffuser 108 and pass through the reheater-condenser 110 and the PDS 112 as it progresses to an aircraft cabin (not shown).

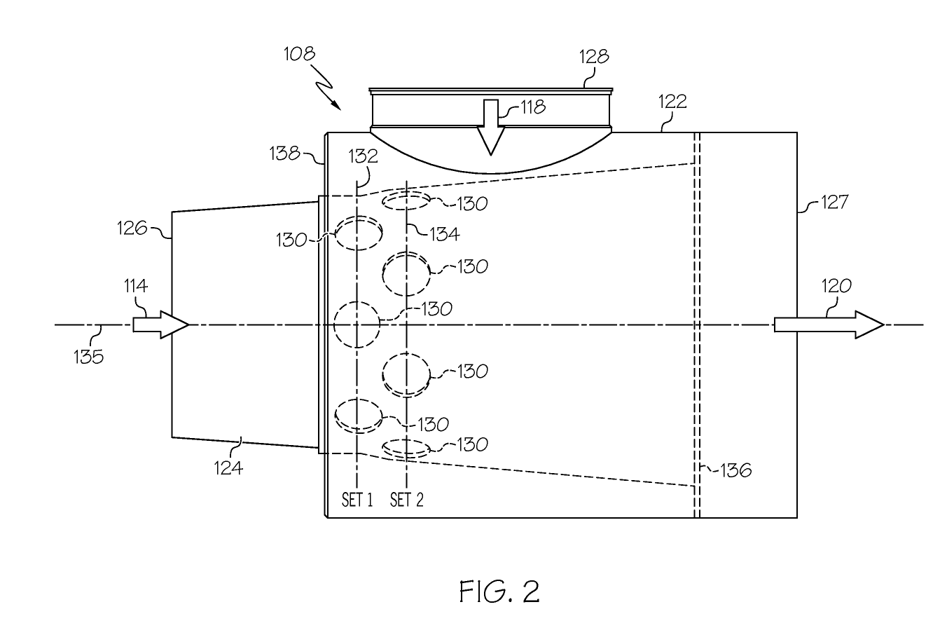

Referring now to FIG. 2, a cut-away view of the mixing diffuser 108 shows that an outer shell 122 may surround a portion of a diffusing cone 124. The cold air 114 may enter the diffusing cone 124 at an inlet end 126 and the mixed airstream 120 may emerge from an output end 127 of the mixing diffuser 108. The hot air 118 may enter the shell 122 at an inlet 128. The hot air 118 may pass through holes 130 formed in the diffusing cone 124. The holes 130 may be arranged in a first set positioned on a centerline 132 and a second set positioned on a centerline 134. The centerlines 132 and 134 may be oriented on a plane that is orthogonal to an axis 135 of the diffusing cone 124. Flow of the hot air 118 may be blocked by a flange 136 of the diffuser cone 124 and an annular end cap 138 of the shell 122 thus assuring that the hot air 118 may flow only through the holes 130.

Locations of the holes 130 may be selected so that the presence of the holes 130 in the diffuser cone 124 have only a minimal impact on the diffusing capability of the diffuser cone 124. Hot air 118 entering the shell 122 may produce a relatively high air pressure near the annular end cap 138. Consequently, high-pressure hot air 118 may also be present at the holes 130, which may be located only short distances from the annular end cap 138. When high-pressure hot air 118 is present at the holes 130, the diffuser cone 124 may behave as if its diffusing capability is virtually undiminished by the presence of the holes 130.

In an exemplary embodiment, all of the holes may have the same diameter. A distance between the centerline 132 and the annular end cap 138 may be no greater than a diameter of one of the holes 130. Also, a distance between the centerlines 132 and 134 may be no greater than a diameter of one of the holes 130. Such a hole-spacing arrangement may result in each hole 130 being close to the annular end cap 138 while being surrounded with only enough of the material of the diffuser cone 124 so that structural integrity of the diffusing cone 124 is preserved. In the exemplary embodiment described above the hole-surrounding material may be at least as wide as a radius of one of the holes 130.

As described above, the hot air 118 may experience a pressure increase near the annular end cap 138. This increased pressure may develop around the entire circumference of the diffuser cone 124. Consequently, the hot air 118 may enter all of the holes 130 at substantially equal flow rates. Thus there may be a low likelihood that the mixed airstream 120 will experience thermal stratification.

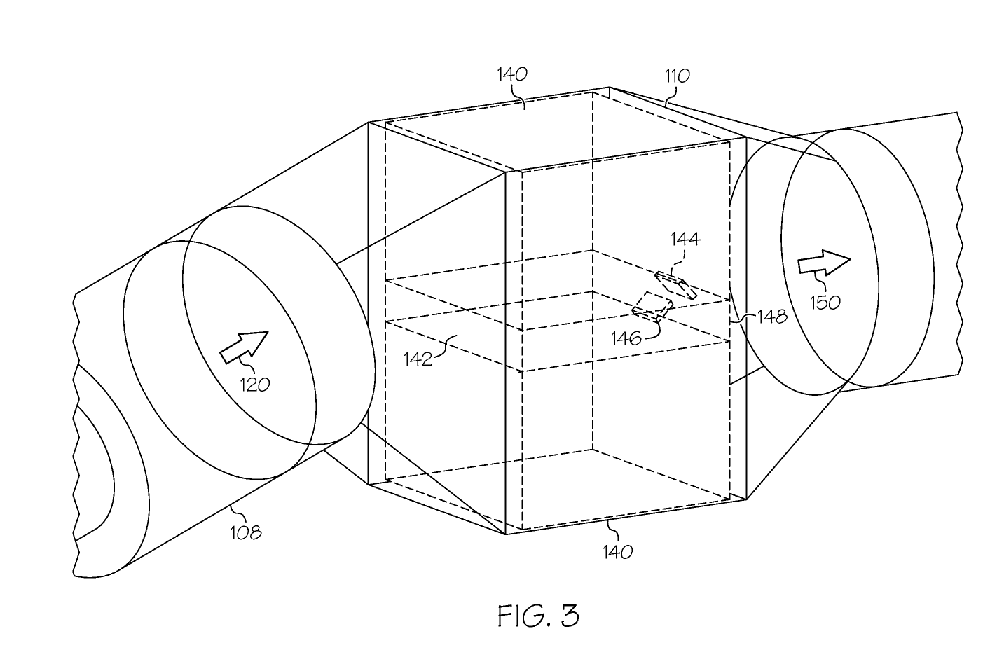

Referring now to FIGS. 3, 4 and 5, there are shown various aspects of the reheater-condenser 110 which contribute to further mixing of the mixed airstream 120. In an exemplary embodiment, the mixed airstream 120 may flow through two heat exchangers 140 and through a by-pass gap 142 between the heat exchangers 140. Mixing tabs 144 and 146 may be positioned at an output end 148 of the by-pass gap 142. As the mixed airstream 120 passes over the mixing tabs 144 and 146, the mixed airstream 120 may be further mixed and transformed into airstream 150.

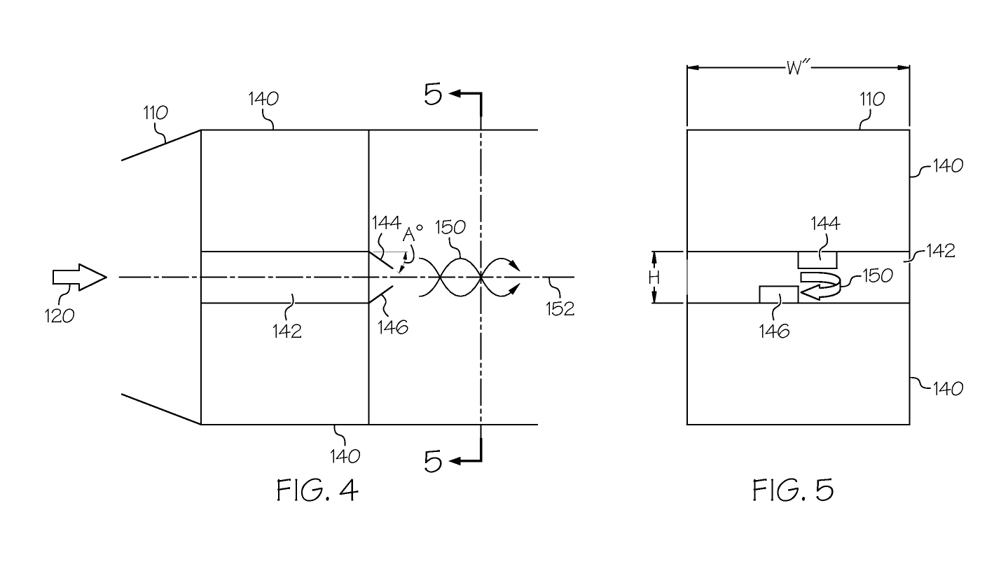

Referring more particularly to FIGS. 4 and 5, it may be seen that the tabs 144 and 146 may be oriented at an angle A relative to a plane that is parallel to an axis 152 of the by-pass gap. In an exemplary embodiment, the angle A may be about 40° to about 60°. Additionally, the tabs 144 and 146 may each have a width that is only about ⅙ of the width W of the by-pass gap 142. Also, the tabs 144 and 146 may have a height that is about ⅓ of a height H of the by-pass gap 142. Each of these dimensional features of the tabs 144 and 146 may, individually and/or collectively, provide that the tabs 144 and 146 may produce only minimal pressure drop in the mixed airstream 120 as the mixed airstream 120 passes over the tabs 144 and 146.

It may be noted in FIG. 5, that the tabs 144 and 146 may be laterally offset from one another. When considering the view of FIG. 5, the tab 144 may be positioned to the right of the tab 146 by a distance of about the width of the tab 146. The offset arrangement of the tabs 144 and 146 may produce an advantageous swirling effect on the mixed airstream 120 as it passes over the tabs 144 and 146. As shown in FIG. 5, clockwise swirling may be produced. The tabs 144 and 146 may be offset from one another to produce either clockwise or counterclockwise swirling. In an exemplary embodiment, it may be beneficial to provide offsetting that produces swirling in the same direction that the expansion turbine 106 of FIG. 1 produces swirling. In that construct, swirling produced by the tabs 144 and 146 may reinforce swirling produced by the expansion turbine 106. Swirling of the mixed airstream 120 may further reduce the likelihood that thermal stratification will be present in the airstream 150.

It should be understood, of course, that the foregoing relates to exemplary embodiments of the invention and that modifications may be made without departing from the spirit and scope of the invention as set forth in the following claims.

We claim:

1. An environmental control system (ECS) for an aircraft comprising:
a mixing diffuser configured to admit a stream of cold air and a stream of hot air; and
a reheater-condenser fluidly coupled with an output end of the mixing diffuser,
wherein the mixing diffuser includes a diffuser cone with a plurality of holes configured to allow passage of hot air into the stream of cold air so that the cold air and the hot air are combined to produce a mixed airstream, and
wherein the reheater-condenser includes mixing tabs configured to produce further mixing of the mixed airstream.

2. The ECS of claim 1:
wherein the diffuser cone is fluidly coupled with an expansion turbine to receive the stream of cold air;
wherein a portion of the diffuser cone is surrounded by a shell fluidly coupled with a compressor discharge duct to receive the hot air;
wherein the diffuser cone is positioned to receive the stream of cold air as axial flow; and
wherein the holes in the diffuser cone are configured to admit the hot air into the diffuser cone as radial flow.

3. The ECS of claim 2:
wherein the shell includes an annular end cap surrounding the diffuser cone;
wherein a first set of the holes in the diffuser cone are positioned on a first circumferential centerline displaced from the annular end cap by a distance no greater than a diameter of one of the holes; and
wherein a second set of the holes in the diffuser cone are positioned on a second circumferential centerline displaced from the annular end cap by a distance no greater than two diameters of one of the holes.

4. The ECS of claim 1:
wherein the reheater-condenser includes a by-pass gap axially aligned with an axis of the diffuser cone of the mixing diffuser; and
wherein the mixing tabs project into the by-pass gap.

5. The ECS of claim 4 wherein the mixing tabs are oriented at an angle A relative to an axis of the by-pass gap, the angle A being between about 40° to about 60°.

6. The ECS of claim 4:
wherein the reheater-condenser includes two of the mixing tabs;
wherein a first one of the tabs projects into the by-pass gap in a first direction; and
wherein a second one of the mixing tabs projects into the by-pass gap in a second direction opposite the first direction; and
wherein the mixing tabs are laterally offset from one another so that the mixed airstream passing the mixing tabs is induced to swirl.

7. The ECS of claim 6 wherein the mixing tabs are offset from one another in a direction so that swirling induced by the mixing tabs is in the same direction as swirling induced in an expansion turbine positioned upstream from the reheater-condenser.

8. An environmental control system (ECS) for an aircraft comprising a mixing diffuser configured to admit a stream of cold air and a stream of hot air, the mixing diffuser including a diffuser cone with a plurality of holes configured to allow passage of hot air into the stream of cold air so that the cold air and the hot air are combined to produce a mixed airstream.

9. The ECS of claim 8:
wherein the diffuser cone is fluidly coupled with an expansion turbine to receive the stream of cold air;
wherein a portion of the diffuser cone is surrounded by a shell fluidly coupled with a compressor discharge duct to receive the hot air;
wherein the diffuser cone is positioned to receive the stream of cold air as axial flow; and
wherein the holes in the diffuser cone are configured to admit the hot air into the diffuser cone as radial flow.

10. The ECS of claim 8:
wherein the shell includes an annular end cap surrounding the diffuser cone; and
wherein a first set of the holes in the diffuser cone are positioned on a first circumferential centerline displaced from the annular end cap by a distance no greater than a diameter of one of the holes.

11. The ECS of claim 10 wherein the first circumferential centerline is oriented on a plane that is orthogonal to an axis of the diffuser cone.

12. The ECS of claim 10 wherein the holes of the first set of holes are equally spaced around the first circumferential centerline.

13. The ECS of claim 10 wherein a second set of the holes in the diffuser cone are positioned on a second circumferential centerline displaced from the annular end cap by a distance no greater than two diameters of one of the holes.

14. The ECS of claim 13 wherein the holes of the second set of holes are equally spaced around the second circumferential centerline.

15. An environmental control system (ECS) for an aircraft comprising a re-heater-condenser fluidly coupled with an output end of a mixing diffuser to receive a mixed air stream from said output end, the reheater-condenser including mixing tabs configured to produce further mixing of a mixed air stream emerging from the mixing diffuser.

16. The ECS of claim 15:
wherein the reheater-condenser includes a by-pass gap axially aligned with an axis of a diffuser cone of the mixing diffuser; and
wherein the mixing tabs project into the by-pass gap.

17. The ECS claim 16 wherein the mixing tabs are oriented at an angle A relative to an axis of the by-pass gap, the angle A being between about 40° to about 60°.

18. The ECS of claim 16:
wherein the reheater-condenser includes two of the mixing tabs;
wherein a first one of the tabs projects into the by-pass gap in a first direction; and
wherein a second one of the mixing tabs projects into the by-pass gap in a second direction opposite the first direction.

19. The ECS of claim 18 wherein the mixing tabs are laterally offset from one another so that an air stream passing the mixing tabs is induced to swirl.

20. The ECS of claim 19 wherein the mixing tabs are offset from one another in a direction so that swirling induced by the mixing tabs is in the same direction as swirling induced in an expansion turbine positioned upstream from the reheater-condenser.
